(19) United States
(12) Patent Application Publication
(10) Pub. No.: US 2024/0241208 A1
(43) Pub. Date: Jul. 18, 2024

(54) METHOD AND DEVICE FOR PROVIDING LOCATION ESTIMATION SERVICE IN WIRELESS COMMUNICATION SYSTEM

(71) Applicant: SAMSUNG ELECTRONICS CO., LTD., Suwon-si, Gyeonggi-do (KR)

(72) Inventors: Taeseop LEE, Suwon-si (KR); Beomsik BAE, Suwon-si (KR)

(21) Appl. No.: 18/559,775

(22) PCT Filed: Apr. 19, 2022
(86) PCT No.: PCT/KR2022/095088

§ 371 Date: Nov. 8, 2023

(30) Foreign Application Priority Data
May 10, 2021 (KR) 10-2021-0060328

(51) Int. Cl. G01S 5/00; G01S 5/02; H04W 64/00

(52) U.S. Cl. CPC G01S 5/01; G01S 5/0268; H04W 64/00

(57) ABSTRACT

The disclosure provides a method by which a location management function (LMF) and a user equipment (UE) exchange a long-term evolution (LTE) positioning protocol (LPP) message related to location estimation. In particular, the method may include performing, by the LMF, a procedure for exchanging UE capability information related to location estimation with the UE, transmitting assistance information for signal measurement by the UE, and requesting and obtaining a measurement result from the UE.

### TECHNICAL FIELD

The disclosure relates to a method and apparatus for providing a location estimation service in a wireless communication system.

### BACKGROUND ART

Fifth generation (5G) mobile communication technologies define wide frequency bands to allow for high transmission rates and new services, and may also be implemented not only in a sub-6 Gigahertz (GHz) band, e.g., 3.5 GHZ, but also in an ultrahigh frequency band (above 6 GHZ) referred to as millimeter waves (mmWave) such as 28 GHz and 39 GHz. Moreover, for sixth generation (6G) mobile communication technologies referred to as a beyond 5G system, it is considered to be implemented in Terahertz (THz) bands (e.g., bands from 95 GHz to 3 THz) to attain transmission rates 50 times higher than an ultra-low delay reduced to one-tenth of the 5G mobile communication technology.

In an early stage of the 5G mobile communication technology, beamforming and massive multiple input multiple output (MIMO) to mitigate a radio path loss and increase the radio propagation distance in the ultra-high frequency band, support for various numerologies (operation of multiple subcarrier spacing) and dynamic slot format operation for efficient use of ultra-high frequency resources, initial access technologies for supporting multiple-beam transmission and widebands, definition and operation of bandwidth parts (BWPs), new channel coding schemes such as polar codes for highly reliable transmission of control information and low density parity check (LDPC) codes for high-volume data transmission, L2 preprocessing, network slicing for providing a dedicated network specialized for a particular service, etc., were standardized to support services and satisfy performance requirements for enhanced mobile broadband (eMBB), ultra-reliable low-latency communications (URLLC), and massive machine-type communications (mMTC).

Improvement and performance enhancement of the early 5G mobile communication technology are currently being discussed with consideration for the services that the 5G mobile communication technology has intended to support, and physical layer standardization for technologies such as vehicle-to-everything (V2X) to help driving decisions of autonomous vehicles and increase user convenience based on locations and status information of the vehicles transmitted by the vehicles, new radio unlicensed (NR-U) to aim at system operations conforming to various regulatory requirements in an unlicensed band, an NR terminal low-power consumption technology (UE power saving), non-terrestrial network (NTN), which is a direct terminal-satellite communication for securing coverage in a region where communication with a terrestrial network is unavailable, positioning, etc., is on going.

In addition, standardization of wireless interface architecture/protocol areas for technologies such as industrial Internet of things (IIoT) for supporting new services through connection and convergence with other industries, integrated access and backhaul (IAB) that provides a node to integrally support the wireless backhaul link and the access link to extend the network service area, mobility enhancement including conditional handover and dual active protocol stack (DAPS) handover, 2-step random access channel (RACH) for new radio (NR) to simplify the random access procedure, etc., and standardization of system architectures/service areas such as 5G baseline architectures (e.g., service based architectures or service based interfaces) for combination of network functions virtualization (NFV) and software-defined networking (SDN), mobile edge computing (MEC) to receive services based on a location of the terminal, etc., is also underway.

When such 5G mobile communication systems are commercialized, explosively increasing connected devices may be connected to the communication network, so that it is expected that enhancement of functions and performance of the 5G mobile communication system and integrated operation of the connected devices are required. For this, new research will be on the way for 5G performance enhancement and complexity reduction, artificial intelligence (AI) service support, metaverse service support, drone communication, etc., using AI, machine learning (ML) and extended reality (XR) to efficiently support augmented reality (AR), virtual reality (VR), mixed reality (MR), etc.

Advancement of the 5G mobile communication system may also be fundamental to developing not only a multiple antenna transmission technology such as large-scale antennas, array antennas, full dimensional multi-input multi-output (FD-MIMO) and new waveforms for guaranteeing coverage in THz bands of the 6G mobile communication technology, a high-dimensional spatial multiplexing technology using orbital angular momentum (OAM) and metamaterial based lens and antennas to enhance coverage of THz band signals, and a reconfigurable intelligent surface (RIS) technology, but also a full-duplex technology for frequency efficiency improvement and system network enhancement of the 6G mobile communication technology, an AI based communication technology to materialize system optimization by using a satellite and AI from a design stage and internalizing an end-to-end AI support function, a next generation distributed computing technology to materialize sophisticated services beyond the limit of terminal computation capacity by using ultra-high performance communication and computing resources, etc.

### DISCLOSURE

### Technical Problem

The disclosure provides a method and apparatus for providing a location estimation service in a wireless communication system.

### Technical Solution

According to an embodiment of the disclosure, a user equipment (UE) in a wireless communication system includes: a transceiver; and at least one processor coupled to the transceiver, wherein the at least one processor is configured to receive, from a network entity, a long-term evolution (LTE) positioning protocol (LPP) request capabilities message requesting information about a capability of the UE for each of one or more location estimation methods, and transmit, to the network entity, an LPP provide capabilities message including information about a capability of the UE for at least one location estimation method the UE supports among the one or more location estimation methods, and wherein the LPP provide capabilities message includes information indicating whether the UE supports a response time of 10 milliseconds for each of the at least one location estimation methods.

### DESCRIPTION OF DRAWINGS

FIG. 1A illustrates a structure of a long-term evolution (LTE) system, according to an embodiment of the disclosure.

FIG. 1B illustrates a radio protocol architecture of an LTE system, according to an embodiment of the disclosure.

FIG. 1C illustrates a structure of a next generation mobile communication system, according to an embodiment of the disclosure.

FIG. 1D illustrates a radio protocol architecture of a next generation mobile communication system, according to an embodiment of the disclosure.

FIG. 1E illustrates a network structure for providing a UE location estimation service (LoCation Service, hereinafter LCS) in a next generation mobile communication system, according to an embodiment of the disclosure.

FIG. 1F is a sequence chart of a procedure for performing an LCS in a next generation mobile communication system, according to an embodiment of the disclosure.

FIG. 1G is a sequence chart of a detailed LTE positioning protocol (LPP) message exchange procedure in a UE procedure in FIG. 1F, according to an embodiment of the disclosure.

FIG. 1H is a sequence chart showing how an LPP request/provide capability enhanced for exchanging low-latency measurement and response capability (hereinafter, low-latency capability) of a UE is used in a procedure for handling an LCS request 1h-5a/b received by an LMF 1h-03, according to an embodiment of the disclosure.

FIG. 1I is a flowchart of a procedure in which an LMF handles an LCS request based on low-latency capability information of a UE, according to an embodiment of the disclosure.

FIG. 1J is a block diagram illustrating an internal structure of a UE, according to an embodiment of the disclosure.

FIG. 1K is a block diagram illustrating a configuration of a new radio (NR) base station (BS), according to an embodiment of the disclosure.

FIG. 1L is a diagram for describing a network entity, according to an embodiment of the disclosure.

### MODE FOR INVENTION

Operating principles of embodiments of the disclosure will now be described with reference to accompanying drawings. Detailed description of related well-known functions or features, which might obscure the gist of the disclosure, will be omitted in describing the following embodiments of the disclosure. Further, the terms, as will be mentioned later, are defined by taking functionalities in the disclosure into account, but may vary depending on practices or intentions of users or operators. Accordingly, the terms should be defined based on descriptions throughout this specification. Embodiments of the disclosure will now be described with reference to accompanying drawings.

For the same reason, some parts in the accompanying drawings are exaggerated, omitted or schematically illustrated. The size of the respective elements may not fully reflect their actual size. Like or corresponding numbers refer to like elements throughout the drawings.

Advantages and features of the disclosure, and methods for achieving them will be understood more clearly when the following embodiments are read with reference to the accompanying drawings. The embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art.

It will be understood that each block and combination of the blocks of a flowchart may be performed by computer program instructions. The computer program instructions may be loaded on a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-executable or computer-readable memory that may direct the computers or other programmable data processing apparatus to function in a particular manner, such that the instructions stored in the computer-executable or computer-readable memory may produce an article of manufacture including instruction means that perform the functions specified in the flowchart blocks(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or the blocks may sometimes be executed in reverse order depending on the corresponding functions.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a smaller number of components and modules, or further divided into a larger number of components and modules. Moreover, the components and modules may be implemented to execute one or more central processing units (CPUs) in a device or security multimedia card. In embodiments, the module may include one or more processors.

Descriptions of some well-known technologies that possibly obscure the disclosure will be omitted, if necessary. Embodiments of the disclosure will now be described with reference to accompanying drawings.

Herein, the terms to identify access nodes, the terms to refer to network entities, the terms to refer to messages, the terms to refer to interfaces among network entities, the terms to refer to various types of identification information, etc., are examples for convenience of explanation. Accordingly, the disclosure is not limited to the terms as herein used, and may use different terms to refer to the items having the same meaning in a technological sense.

Hereinafter, for convenience of explanation, the disclosure uses the terms and names defined by the 3rd generation partnership project long-term evolution (3GPP LTE). The disclosure is not, however, limited to the terms and definitions, and may be equally applied to any systems that conform to other standards. In the disclosure, evolved node B (eNB) may be interchangeably used with gNB. For example, a base station referred to as an eNB may also indicate a gNB.

In the following description, a base station is an entity for performing resource allocation for a terminal, and may be at least one of a gNB, an eNB, a Node B, a base station (BS), a radio access unit, a base station controller, or a network node. The terminal may include a user equipment (UE), a mobile station (MS), a cellular phone, a smart phone, a computer, or a multimedia system capable of performing a communication function. It is, of course, not limited thereto.

Although the following embodiments of the disclosure will now be focused on an LTE, LTE-A, LTE Pro or fifth generation (5G) (or new radio (NR), next generation mobile communication) system for example, they may be equally applied to other communication systems with similar technical backgrounds or channel types. Furthermore, embodiments of the disclosure will also be applied to different communication systems with some modifications to such an extent that they do not significantly deviate from the scope of the disclosure when judged by those of ordinary skill in the art.

Descriptions of some well-known technologies that possibly obscure the disclosure will be omitted, if necessary. Embodiments of the disclosure will now be described with reference to accompanying drawings.

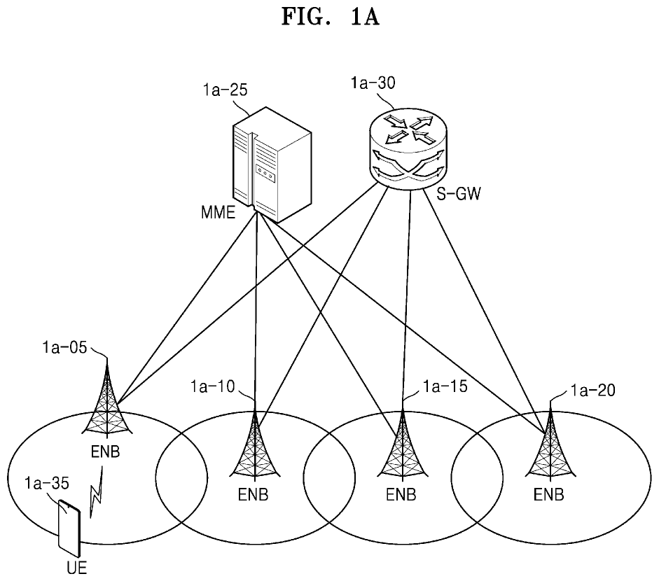

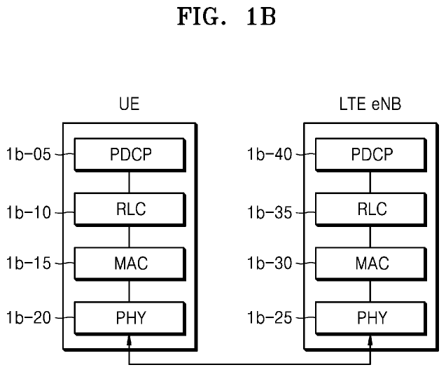

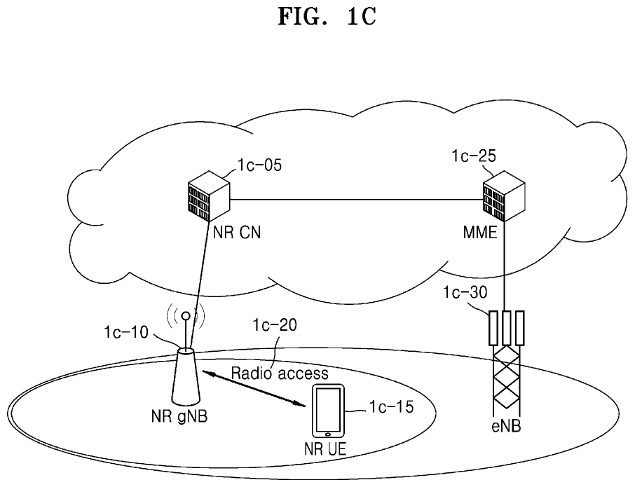

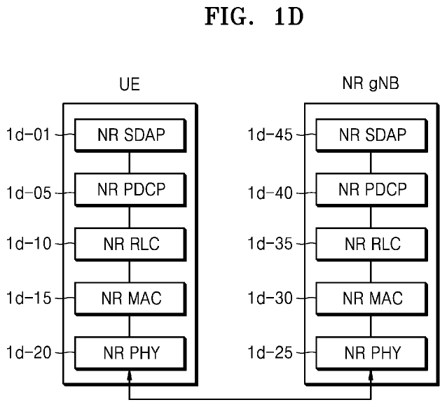

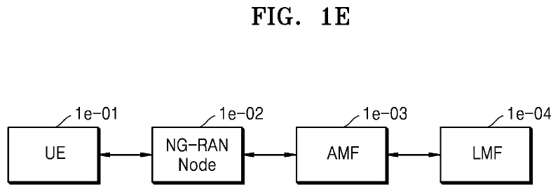

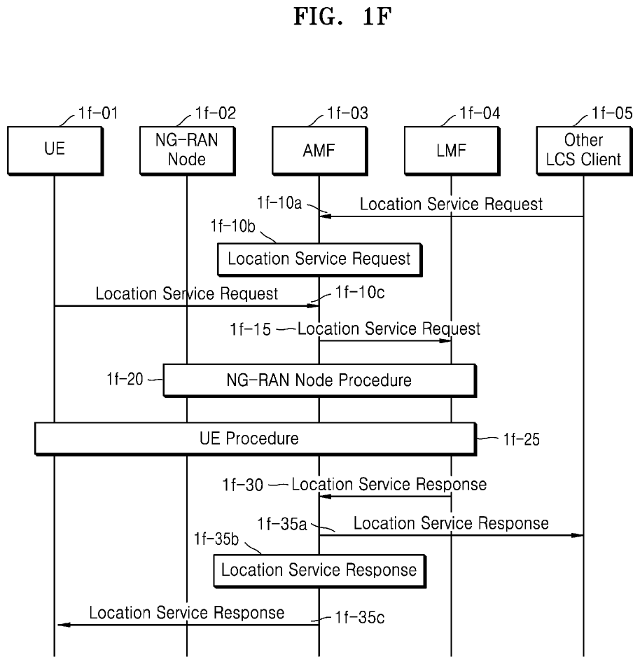

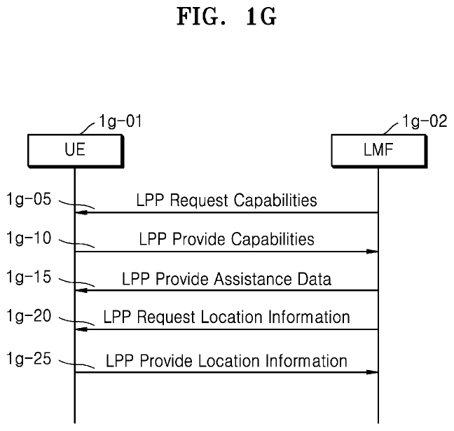

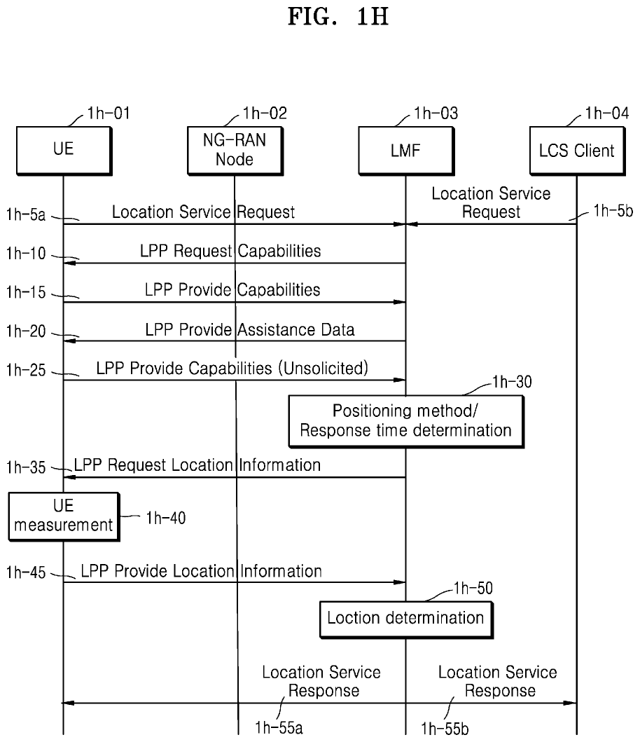

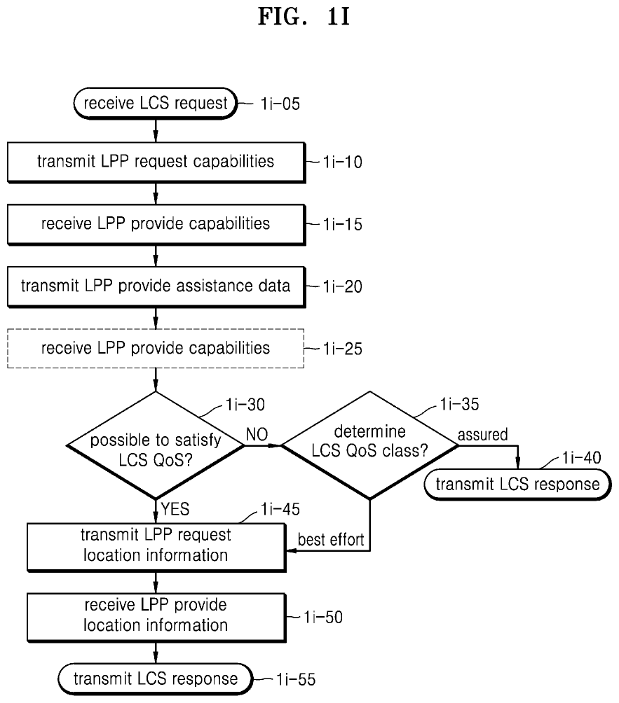

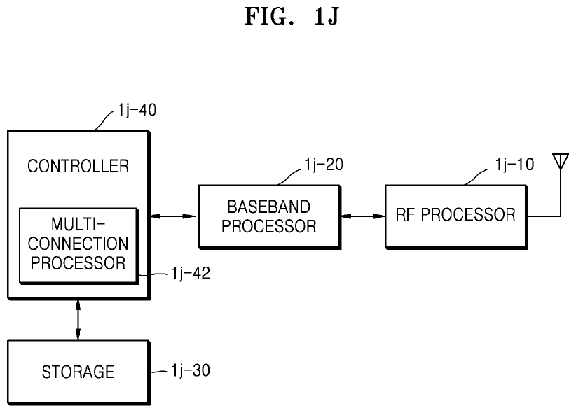

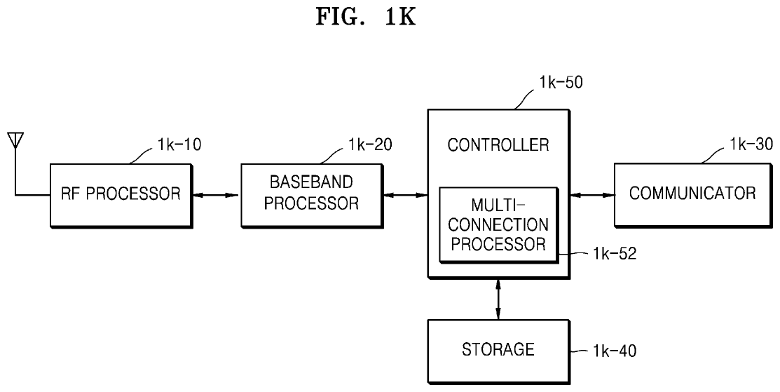

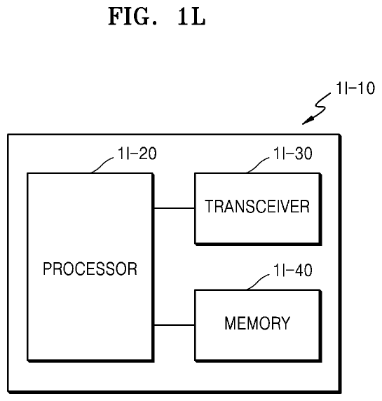

FIG. 1A illustrates a structure of an LTE system, according to an embodiment of the disclosure.

Referring to FIG. 1A, a radio access network of an LTE system may include eNBs (or Node Bs or base stations (BSs)) 1a-05, 1a-10, 1a-15, and 1a-20, a mobility management entity (MME) 1a-25, and a serving gateway (S-GW) 1a-30. Obviously, it is not limited thereto, and the wireless network may include more entities. A UE or a terminal 1a-35 may connect to an external network via the eNB 1a-05, 1a-10, 1a-15, or 1a-20, and the S-GW 1a-30.

In FIG. 1A, the eNBs 1a-05, 1a-10, 1a-15 and 1a-20 may correspond to the existing node Bs in a universal mobile telecommunication system (UMTS). The eNB may be connected to the UE 1a-35 via a wireless channel, and may play a more sophisticated role than the existing node B does. In the LTE system, all user traffic including real-time services such as voice over Internet protocol (VOIP) services through an Internet protocol is served on a shared channel, so a device for collecting state information, such as buffer states, available transmit power states, channel states, etc., of UEs for scheduling is required, and the eNB 1a-05, 1a-10, 1a-15 or 1a-20 serves as the device. A single eNB may control a plurality of cells. To achieve e.g., 100 Mbps of transmission rate, the LTE system may use orthogonal frequency division multiplexing (OFDM) in e.g., 20 MHz bandwidth as a radio access technology. Obviously, the radio access technology that may be used by the LTE system is not limited to the above example.

An adaptive modulation and coding (AMC) scheme to determine a modulation scheme and a channel coding rate according to a channel condition of the UE may also be used by the LTE system. The S-GW 1a-30 is a device to provide a data bearer, producing or eliminating the data bearer under the control of the MME 1a-25. The MME 1a-25 is a device responsible for various control functions as well as mobility management functionality for the UE, and may be connected to a plurality of BSs.

FIG. 1B illustrates a radio protocol architecture of an LTE system, according to an embodiment of the disclosure.

Referring to FIG. 1B, a radio protocol of the LTE system may include in each of a UE and an eNB, a packet data convergence protocol (PDCP) layer 1b-05 or 1b-40, a radio link control (RLC) layer 1b-10 or 1b-35, and a medium access control (MAC) layer 1b-15 or 1b-30. The PDCP layer 1b-05 or 1b-40 may perform an operation such as IP header compression/decompression. Main functions of the PDCP layer may be summarized as follows: Obviously, it is not limited to the following examples.
header compression and decompression function (e.g., header compression and decompression: robust header compression (ROHC) only)
user data transfer function
sequential delivery function (e.g., in-sequence delivery of upper layer Packet Data Units (PDUs) at PDCP re-establishment procedure for RLC AM)
reordering function (e.g., for split bearers in DC (only support for RLC AM): PDCP PDU routing for transmission and PDCP PDU reordering for reception)
duplicate detection function (e.g., duplicate detection of lower layer SDUs at PDCP re-establishment procedure for RLC AM)
retransmission function (e.g., retransmission of PDCP SDUs at handover and, for split bearers in DC, of PDCP PDUs at PDCP data-recovery procedure, for RLC acknowledged mode (AM))
ciphering and deciphering function
timer-based SDU discarding function (e.g., timer-based SDU discarding in uplink)

The RLC 1b-10 and 1b-35 may reconfigure a PDCP PDU to be in a proper size, and perform operation, such as Automatic Repeat reQuest (ARQ). Main functions of the RLC layer may be summarized as follows: Obviously, it is not limited to the following examples.
data transfer function (e.g., transfer of upper layer PDUs)
ARQ function (e.g., Error Correction through ARQ (only for AM data transfer))
concatenation, segmentation, and reassembling function (e.g., concatenation, segmentation and reassembly of RLC SDUs (only for UM and AM data transfer))
re-segmentation function (e.g., re-segmentation of RLC data PDUs (only for AM data transfer))
reordering function (e.g., reordering of RLC data PDUs (only for UM and AM data transfer))
duplicate detection function (e.g., duplicate detection (only for UM and AM data transfer))
error detection function (e.g., protocol error detection (only for AM data transfer))
RLC SDU discard function (e.g., RLC SDU discard (only for UM and AM data transfer))
RLC re-establishment function

The MAC layer 1b-15 and 1b-30 may be connected to various RLC layer devices configured in one UE and may multiplex RLC PDUs to an MAC PDU and demultiplex an MAC PDU to RLC PDUs. Main functions of the MAC layer may be summarized as follows: Obviously, it is not limited to the following examples.
mapping function (e.g., mapping between logical channels and transport channels)
multiplexing and demultiplexing function (e.g., multiplexing/demultiplexing of MAC SDUs belonging to one or different logical channels into/from transport blocks (TB) delivered to/from the physical layer on transport channels)
scheduling information report function
HARQ function (e.g., error correction through HARQ)
logical channel priority control function (e.g., priority handling between logical channels of one UE)
UE priority control function (e.g., priority handling between UEs by means of dynamic scheduling)
MBMS service identification function
transport format selection function
padding function

A physical layer (PHY) 1b-20 or 1b-25 may encode and modulate higher layer data into OFDM symbols and transmit them on a radio channel, or may demodulate OFDM symbols received on a radio channel, perform channel decoding on them and send the result to a higher layer.

FIG. 1C illustrates a structure of a next generation mobile communication system, according to an embodiment of the disclosure.

Referring to FIG. 1C, a radio access network of the next generation mobile communication (hereinafter, NR or 2g) system includes an NR node B (hereinafter, NR NB, gNB, NR gNB or NR BS) 1c-10, and an NR core network (CN) 1c-05. Obviously, it is not limited thereto, and the radio access network of the NR system may include more entities. A UE (NR UE or terminal) 1c-15 may access an external network via the NR gNB 1c-10 and the NR CN 1c-05.

In FIG. 1C, the NR gNB 1c-10 corresponds to an eNB of the existing LTE system. The NR gNB 1c-10 may be connected to the NR UE 1c-15 over a radio channel 1c-20 and may provide a far better service than that of the existing Node B. In the NR system, all user traffic is served on a shared channel, so a device for collecting state information, such as buffer states, available transmit power states, channel states, etc., of UEs for scheduling is required, and the NR gNB 1c-10 serves as the device. A single NR gNB 1c-10 may control a plurality of cells.

According to an embodiment of the disclosure, the NR system may have bandwidth corresponding to the existing maximum bandwidth or higher to attain ultrahigh rate data transfer as compared to the existing LTE, and provide an additional beamforming technology with the OFDM radio access technology. The NR system may also use an adaptive modulation and coding (AMC) scheme to determine a modulation scheme and a channel coding rate according to the channel condition of the UE. The NR CN 1c-05 may perform such functions as supporting mobility, setting up a bearer, setting quality of service (QOS), etc. The NR CN 1c-05 is a device responsible for various control functions as well as mobility management functionality for the UE, and may be connected to a plurality of BSs. Furthermore, the NR system may work with the existing LTE system, in which case the NR CN 1c-05 may be connected to an MME 1c-25 through a network interface. The MME may be connected to an existing BS, eNB 1c-30.

FIG. 1D illustrates a radio protocol architecture of an NR system, according to an embodiment of the disclosure.

Referring to FIG. 1D, a radio protocol of the NR system includes in each of the UE and the NR gNB, an NR SDAP layer 1d-01 or 1d-45, an NR PDCP layer 1d-05 or 1d-40, an NR RLC layer 1d-10 or 1d-35 and an NR MAC layer 1d-15 or 1d-30. Main functions of the NR SDAP layer 1d-01 or 1d-45 may include some of the following functions: Obviously, it is not limited to the following examples.
a function of transfer of user plane data
mapping between a QoS flow and a data bearer (DRB) for both DL and UL
function of marking QoS flow identification (ID) for both UL and DL
function of mapping of a reflective QoS flow to a DRB for UL SDAP PDUs

For an SDAP layer device, the UE may receive configuration of whether to use a header of the SDAP layer device or whether to use a function of the SADP layer device for each PDCP layer device or each bearer or each logical channel in an RRC message, and when the SDAP header is configured, a 1-bit non-access stratum (NAS) reflective QoS indicator (NAS reflective QoS) and a 1-bit access stratum (AS) reflective Qos (AS reflective QoS) may indicate for the UE to update or reconfigure the mapping information between the QoS flow and the data bearer for UL or DL. Furthermore, in an embodiment of the disclosure, the SDAP header may include QoS flow ID information indicating QoS. The QoS information may be used for data process priority, scheduling, etc., for smoother services.

Main functions of the NR PDCP layer 1d-05 or 1d-40 may include some of the following functions: Obviously, it is not limited to the following examples.
header compression and decompression function (e.g., header compression and decompression: robust header compression (ROHC) only)
user data transfer function
sequential delivery function (e.g., in-sequence delivery of upper layer PDUs)
non-sequential delivery function (e.g., out-of-sequence delivery of upper layer PDUs)
reordering function (e.g., PDCP PDU reordering for reception)
duplicate detection function (e.g., duplicate detection of lower layer SDUs)
retransmission function (e.g., retransmission of PDCP SDUs)
ciphering and deciphering function
timer-based SDU discarding function (e.g., timer-based SDU discarding in uplink)

The reordering function of the NR PDCP 1d-05 and 1d-40 may refer to a function of reordering PDCP PDUs received from a lower layer based on PDCP sequence numbers (SNs), and include a function of transferring data to a higher layer in the reordered sequence or transferring the data directly to the higher layer without considering the sequence. Furthermore, the reordering function of the NR PDCP device may include a function of reordering the sequence to record missing PDCP PDUs, a function of reporting status of missing PDCP PDUs to a transmitting end, or a function of requesting retransmission of missing PDCP PDUs.

Main functions of the NR RLC layer 1d-10 or 1d-35 may include some of the following functions: Obviously, it is not limited to the following examples.
data transfer function (e.g., transfer of upper layer PDUs)
sequential delivery function (e.g., in-sequence delivery of upper layer PDUs)
non-sequential delivery function (e.g., out-of-sequence delivery of upper layer PDUs)
ARQ function (e.g., error correction through ARQ)
concatenation, segmentation, and reassembling function (e.g., concatenation, segmentation and reassembly of RLC SDUs)
re-segmentation function (e.g., re-segmentation of RLC data PDUs)
reordering function (e.g., reordering of RLC data PDUs)
duplicate detection function
error detection function (e.g., protocol error detection)
RLC SDU discard function
RLC re-establishment function

In the aforementioned description, the sequential delivery function of the NR RLC device 1d-10 and 1d-35 may refer to a function of delivering RLC SDUs received from a lower layer to a higher layer in sequence, and include a function of receiving, reassembling and delivering multiple RLC SDUs resulting from segmentation of an original RLC SDU, and a function of reordering the received RLC PDUs based on RLC SNs or PDCP SNs. Furthermore, the sequential delivery function of the NR RLC device 1d-10 and 1d-35 may include a function of reordering the sequence to record missing RLC PDUs, a function of reporting status of missing RLC PDUs to a transmitting end, or a function of requesting retransmission of missing RLC PDUs. The sequential delivery function of the NR RLC device may include, when there is a missing RLC SUD, a function of delivering RLC SDUs before the missing RLC SDU to a higher layer in sequence, or when there is a missing RLC SDU but a timer is expired, a function of delivering all the RLC SDUs received before the timer starts to a higher layer in sequence, or when there is a missing RLC SDU but a timer is expired, a function of delivering all the RLC SDUs received up to the present to a higher layer in sequence. Furthermore, the NR RLC device may also process the RLC PDUs in the order of reception (or in the order of arrival without regard to the order of the SNs) and deliver the RLC PDUs to a PDCP device regardless of the sequence (out-of-sequence delivery), or when the RLC PDU is segmented, reassemble the segments stored in a buffer or to be received later into a complete RLC PDU, process and deliver the RLC PDU to the PDCP device. The NR RLC layer may not include a concatenation function, and the concatenation function may be performed in the NR MAC layer or replaced with a multiplexing function of the NR MAC layer.

In the aforementioned description, the non-sequential delivery function of the NR RLC device 1d-10 and 1d-35 may refer to a function of delivering RLC SDUs received from a lower layer directly to a higher layer without regard to the sequence of the RLC SDUs, and include a function of receiving, reassembling and delivering multiple RLC SDUs resulting from segmentation of an original RLC SDU, or a function of storing RLC SNs or PDCP SNs of the received RLC PDUs and reordering the received RLC PDUs to record missing RLC PDUs.

The NR MAC layer 1d-15 and 1d-30 may be connected to multiple NR RLC layer devices configured in the same UE, and main functions of the NR MAC layer may include some of the following functions: It is, of course, not limited to the following example.
mapping function (e.g., mapping between logical channels and transport channels)
multiplexing and demultiplexing function (e.g., multiplexing/demultiplexing of MAC SDUs)
scheduling information report function
HARQ function (e.g., error correction through HARQ)
logical channel priority control function (e.g., priority handling between logical channels of one UE)
UE priority control function (e.g., priority handling between UEs by means of dynamic scheduling)
MBMS service identification function
transport format selection function
padding function

The NR PHY layer 1d-20 or 1d-25 may perform channel coding and modulation on higher layer data, form the data into OFDM symbols and send them on a radio channel, or may demodulate OFDM symbols received on a radio channel, perform channel decoding on them and send the result to a higher layer.

FIG. 1E illustrates a network structure for providing a UE location estimation service (LoCation Service, hereinafter LCS) in an NR system, according to an embodiment of the disclosure.

Referring to FIG. 1E, a network for providing an LCS in the NR system includes a UE 1e-01, a BS (NG-RAN node) 1e-02, an access and mobility function (AMF) 1e-03, and a location management function (LMF) 1e-04. In this case, the UE 1e-01 communicates with the LMF 1e-04 through the BS 1e-02 and the AMF 1e-03 to exchange information required for estimation of the location. Roles of the respective components to provide an LCS are as follows:

The UE 1e-01 may serve to measure a wireless signal required for estimating the location and send the result to the LMF 1e-04.

The BS 1e-02 may serve to transmit a downlink (DL) wireless signal required for estimating a location and measure an uplink (UL) wireless signal transmitted by a target UE.

The AMF 1e-03 may serve to receive an LCS request message from an LCS requester and forward the LCS request message to the LMF 1e-04 to instruct to provide a service for providing a location. When the LMF 1e-04 handles the location estimation request and responds with a result of estimating the location of the UE, the AMF 1e-03 may forward the result to the LCS requester.

The LMF 1e-04 is a device for receiving the LCS request from the AMF 1e-03 and handling the LCS request, and may serve to control an overall procedure required for location estimation. For estimation of a UE location, the LMF 1e-04 may provide the UE 1e-01 with assistance information required for location estimation and signal measurement and receive the resultant value, and in this case, an LTE positioning protocol (LPP) may be used for data exchange. The LPP may define a standard for messages to be exchanged between the UE 1e-01 and the LMF 1e-04 for a location estimation service. Furthermore, the LMF 1e-04 may exchange DL reference signal (or positioning reference signal (PRS)) configuration information and a UL reference signal (or sounding reference signal (SRS) measurement to be used for location estimation even with the BS 1e-02. In this case, as a protocol for data exchange, an NR positioning protocol A (NRPPa) may be used, and the NRPPa may define a standard for messages to be exchanged between the BS 1e-02 and the LMF 1e-04.

FIG. 1F is a sequence chart of a procedure for performing an LCS in an NR system, according to an embodiment of the disclosure.

Referring to FIG. 1F, an AMF 1f-03 may receive an LCS request 1f-10a/b/c and forward the LCS request 1f-10a/b/c to the LMF 1f-04. Afterward, the LMF 1f-04 may control processes of exchanging required information with the UE and the BS to handle the LCS request 1f-10a/b/c, and send the resultant value (a location estimation result) to the AMF 1f-03. The LCS operation may be completed when the AMF 1f-03 sends the resultant value to an entity that has sent the LCS request.

There are three types of LCS request to be received by the AMF 1f-03 in operation 1f-10.
1. LCS request 1f-10a received from an external LCS client 1f-05
2. LCS request 1f-10b self-generated by the AMF 1f-03
3. LCS request 1f-10c received from a UE 1f-01

After receiving one of the three types of LCS request, the AMF 1f-03 may request to provide a location estimation service by transmitting a location service request message 1f-15 to the LMF 1f-04. Afterward, in an NG-RAN node procedure 1f-20, the LMF 1f-04 may perform processes required for location estimation (e.g., setting up BS PRS, obtaining BS SRS measurement) through NRPPa message exchange with the NG-RAN node 1f-02. Furthermore, in a UE procedure 1f-25, the LMF 1f-04 may exchange an LPP message to exchange required information with the UE 1f-01. Through the above procedures, the LMF 1f-04 may perform processes of exchanging information about UE capability related to location estimation, sending assistance information for signal measurement of the UE, requesting and obtaining UE measurement results, etc. When the LMF 1f-04 determines an estimated location of the UE based on various measurement results obtained, the LMF 1f-04 may send a location service response message 1f-30 to the AMF 1f-03. The AMF 1f-03 may send an LCS response message 1f-35a/b/c to an entity that has requested the LCS, and the LCS response message 1f-35a/b/c may include a UE location estimation result.

FIG. 1G is a sequence chart of a detailed LPP message exchange procedure in the procedure of the UE in FIG. 1F, according to an embodiment of the disclosure.

Referring to FIG. 1G, illustrated are processes of an LMF 1g-02 performing a procedure for exchanging information about a UE capability related to location estimation with a UE 1g-01, sending assistance information for signal measurement of the UE, requesting and obtaining UE measurement results, etc. Usage and definition for each LPP message exchanged in each operation are as follows:
LPP Request Capabilities (LMF→UE, 1g-05)
: may be used by the LMF 1g-02 to request UE capability information relating to location estimation from the UE 1g-01. Information included in the message may be defined as in Table 1 below. A request for common information unrelated to the location estimation method (e.g., GNSS, observed time difference of arrival (OTDOA), enhanced cell ID (ECID), etc.) may be included in CommonIEsRequestCapabilities, and a request for information additionally required for each location estimation method may be included in an extra information element (IE) for each method.

TABLE 1
RequestCapabilities ::= SEQUENCE {

| criticalExtensions | | CHOICE { |
|---|---|---|
| | c1 | CHOICE { |
| | requestCapabilities-r9 | RequestCapabilities-r9-IEs, |
| | spare3 NULL, spare2 NULL, spare1 NULL | |
| | }, | |
| | criticalExtensionsFuture | SEQUENCE { } |

}
}

| RequestCapabilities-r9-IEs ::= | SEQUENCE { | |
|---|---|---|
| commonIEsRequestCapabilities | CommonIEsRequestCapabilities | OPTIONAL, -- Need ON |
| a-gnss-RequestCapabilities | A-GNSS-RequestCapabilities | OPTIONAL, -- Need ON |
| otdoa-RequestCapabilities | OTDOA-RequestCapabilities | OPTIONAL, -- Need ON |
| ecid-RequestCapabilities | ECID-RequestCapabilities | OPTIONAL, -- Need ON |
| epdu-RequestCapabilities | EPDU-Sequence | OPTIONAL, -- Need ON |

...,

| | | | |
|---|---|---|---|
| [[ | sensor-RequestCapabilities-r13 | Sensor-RequestCapabilities-r13 | OPTIONAL, -- Need ON |
| | tbs-RequestCapabilities-r13 | TBS-RequestCapabilities-r13 | OPTIONAL, -- Need ON |
| | wlan-RequestCapabilities-r13 | WLAN-RequestCapabilities-r13 | OPTIONAL, -- Need ON |
| | bt-RequestCapabilities-r13 | BT-RequestCapabilities-r13 | OPTIONAL -- Need ON |

]],

| [[ | nr-ECID-RequestCapabilities-r16 | NR-ECID-RequestCapabilities-r16 | OPTIONAL, -- Need ON |
|---|---|---|---|
| | nr-Multi-RTT-RequestCapabilities-r16 | | |
| | | NR-Multi-RTT-RequestCapabilities-r16 | |
| | | | OPTIONAL, -- Need ON |
| | nr-DL-AoD-RequestCapabilities-r16 | | |
| | | NR-DL-AoD-RequestCapabilities-r16 | OPTIONAL, -- Need ON |
| | nr-DL-TDOA-RequestCapabilities-r16 | | |
| | | NR-DL-TDOA-RequestCapabilities-r16 | OPTIONAL, -- Need ON |
| | nr-UL-RequestCapabilities-r16 | NR-UL-RequestCapabilities-r16 | OPTIONAL -- Need ON |

]]

LPP Provide Capabilities (UE to LMF, 1g-10)
: may be used by the UE 1g-02 to send UE capability information requested from the LMF 1g-02. Information included in the message may be defined as in Table 2 below. Similar to the LPP request capabilities message, common information unrelated to the location estimation method may be included in commonIEsProvideCapabilities and information requested for each location estimation method may be included in an extra IE.

TABLE 2
ProvideCapabilities ::= SEQUENCE {

| criticalExtensions | | CHOICE { |
|---|---|---|
| | c1 | CHOICE { |
| | provideCapabilities-r9 | ProvideCapabilities-r9-IEs, |
| | spare3 NULL, spare2 NULL, spare1 NULL | |
| | }, | |
| | criticalExtensionsFuture | SEQUENCE { } |

}
}

| ProvideCapabilities-r9-IEs ::= | SEQUENCE { | |
|---|---|---|
| commonIEsProvideCapabilities | CommonIEsProvideCapabilities | OPTIONAL, |
| a-gnss-ProvideCapabilities | A-GNSS-ProvideCapabilities, | OPTIONAL, |
| otdoa-ProvideCapabilities | OTDOA-ProvideCapabilities | OPTIONAL, |
| ecid-ProvideCapabilities | ECID-ProvideCapabilities | OPTIONAL, |
| epdu-ProvideCapabilities | EPDU-Sequence | OPTIONAL, |

...,

| | | | |
|---|---|---|---|
| [[ | sensor-ProvideCapabilities-r13 | Sensor-ProvideCapabilities-r13 | OPTIONAL, |
| | tbs-ProvideCapabilities-r13 | TBS-ProvideCapabilities-r13 | OPTIONAL, |
| | wlan-ProvideCapabilities-r13 | WLAN-ProvideCapabilities-r13 | OPTIONAL, |
| | bt-ProvideCapabilities-r13 | BT-ProvideCapabilities-r13 | OPTIONAL |

]],

| [[ | nr-ECID-ProvideCapabilities-r16 | NR-ECID-ProvideCapabilities-r16 | OPTIONAL, |
|---|---|---|---|
| | nr-Multi-RTT-ProvideCapabilities-r16 | | |
| | | NR-Multi-RTT-ProvideCapabilities-r16 | OPTIONAL, |
| | nr-DL-AoD-ProvideCapabilities-r16 | | |
| | | NR-DL-AoD-ProvideCapabilities-r16 | OPTIONAL, |
| | nr-DL-TDOA-ProvideCapabilities-r16 | | |
| | | NR-DL-TDOA-ProvideCapabilities-r16 | OPTIONAL, |
| | nr-UL-ProvideCapabilities-r16 | NR-OL-ProvideCapabilities-r16 | OPTIONAL |

]]
}

LPP ProvideAssistanceData (LMF to UE, 1g-15)
: may be used by the LMF 1g-02 to provide information required by or helpful to the UE 1g-01 to measure wireless signals for location estimation. Information included in the message may be defined as in Table 3 below.

TABLE 3
ProvideAssistanceData ::= SEQUENCE {

| criticalExtensions | | CHOICE { |
|---|---|---|
| | c1 | CHOICE { |
| | provideAssistanceData-r9 | ProvideAssistanceData-r9-IEs, |
| | spare3 NULL, spare2 NULL, spare1 NULL | |
| | }, | |
| | criticalExtensionsFuture | SEQUENCE { } |

}
}
ProvideAssistanceData-r9-IEs ::= SEQUENCE {

| | | |
|---|---|---|
| commonIEsProvideAssistanceData | CommonIEsProvideAssistanceData | OPTIONAL, -- Need ON |
| a-gnss-ProvideAssistanceData | A-GNSS-ProvideAssistanceData | OPTIONAL, -- Need ON |
| otdoa-ProvideAssistanceData | OTDOA-ProvideAssistanceData | OPTIONAL, -- Need ON |
| epdu-Provide-Assistance-Data | EPDU-Sequence | OPTIONAL, -- Need ON |

```
  ...,
  [[
```

| | | |
|---|---|---|
| sensor-ProvideAssistanceData-r14 | Sensor-ProvideAssistanceData-14 | OPTIONAL, -- Need ON |
| tbs-ProvideAssistanceData-r14 | TBS-ProvideAssistanceData-r14 | OPTIONAL, -- Need ON |
| wlan-ProvideAssistanceData-r14 | WLAN-ProvideAssistanceData-r14 | OPTIONAL -- Need ON |

]],

| | |
|---|---|
| [[ | nr-Multi-RTT-ProvideAssistanceData-r16 |

NR-Multi-RTT-ProvideAssistanceData-r16

OPTIONAL, -- Need ON

nr-DL-AoD-ProvideAssistanceData-r16

| | |
|---|---|
| NR-DL-AoD-ProvideAssistanceData-r16 | OPTIONAL, -- Need ON |

nr-DL-TDOA-ProvideAssistanceData-r16

NR-DL-TDOA-ProvideAssistanceData-r16

OPTIONAL -- Need ON

]]
}

LPP Request Location Information (LMF to UE, 1g-20)
: may be used by the LMF 1g-02 to send the UE 1g-01 a request for measurement of signals required for location estimation and the results of location estimation. The LMF 1g-02 may determine which location estimation method is to be used, which measurement is to be performed by the UE for this, how to respond with what result, etc., and send the UE 1g-01 related information in the message. Information included in the message may be defined as in Table 4 below.

TABLE 4
RequestLocationInformation ::= SEQUENCE {

| criticalExtensions | | CHOICE { |
|---|---|---|
| | c1 | CHOICE { |
| | requestLocationInformation-r9 | RequestLocationInformation-r9-IEs, |
| | spare3 NULL, spare2 NULL, spare1 NULL | |
| | }, | |
| | criticalExtensionsFuture | SEQUENCE { } |

```
  }
}
RequestLocationInformation-r9-IEs ::= SEQUENCE {
  commonIEsRequestLocationInformation
```

| | | |
|---|---|---|
| | CommonIEsRequestLocationInformation | OPTIONAL, -- Need ON |
| a-gnss-RequestLocationInformation | A-GNSS-RequestLocationInformation | OPTIONAL, -- Need ON |
| otdoa-RequestLocationInformation | OTDOA-RequestLocationInformation | OPTIONAL, -- Need ON |
| ecid-RequestLocationInformation | ECID-RequestLocationInformation | OPTIONAL, -- Need ON |
| epdu-RequestLocationInformation | EPDU-Sequence | OPTIONAL, -- Need ON |

```
  ...,
  [[
  sensor-RequestLocationInformation-r13
```

| | Sensor-RequestLocationInformation-r13 | |
|---|---|---|
| | | OPTIONAL, -- Need ON |
| tbs-RequestLocationInformation-r13 | TBS-RequestLocationInformation-r13 | OPTIONAL, -- Need ON |
| wlan-RequestLocationInformation-r13 | WLAN-RequestLocationInformation-r13 | OPTIONAL, -- Need ON |
| bt-RequestLocationInformation-r13 | BT-RequestLocationInformation-r13 | OPTIONAL -- Need ON |

]],

| | |
|---|---|
| [[ | nr-ECID-RequestLocationInformation-r16 |

NR-ECID-RequestLocationInformation-r16

OPTIONAL, -- Need ON

nr-Multi-RTT-RequestLocationInformation-r16

NR-Multi-RTT-RequestLocationInformation-r16

OPTIONAL, -- Need ON

nr-DL-AoD-RequestLocationInformation-r16

NR-DL-AoD-RequestLocationInformation-r16

OPTIONAL, -- Need ON

nr-DL-TDOA-RequestLocationInformation-r16

NR-DL-TDOA-RequestLocationInformation-r16

OPTIONAL -- Need ON

]]
}

LPP Provide Location Information (UE to LMF, 1g-25)
: may be used by the UE 1g-01 to send the LMF 1g-02 results of measurement and location estimation requested by the LMF 1g-02. Information included in the message may be defined as in Table 5 below.

TABLE 5
ProvideLocationInformation ::= SEQUENCE {

| criticalExtensions | | CHOICE { |
|---|---|---|
| | c1 | CHOICE { |
| | provideLocationInformation-r9 | ProvideLocationInformation-r9-IEs, |

spare3 NULL, spare2 NULL, spare1 NULL
},
criticalExtensionsFuture SEQUENCE { }

```
  }
}
ProvideLocationInformation-r9-IEs ::= SEQUENCE {
  commonIEsProvideLocationInformation
```

| | | |
|---|---|---|
| | CommonIEsProvideLocationInformation | OPTIONAL, |
| a-gnss-ProvideLocationInformation | A-GNSS-ProvideLocationInformation | OPTIONAL, |
| otdoa-ProvideLocationInformation | OTDOA-ProvideLocationInformation | OPTIONAL, |
| ecid-ProvideLocationInformation | ECID-ProvideLocationInformation | OPTIONAL, |
| epdu-ProvideLocationInformation | EPDU-Sequence | OPTIONAL, |

```
  ...,
  [[
  sensor-ProvideLocationInformation-r13
```

| | Sensor-ProvideLocationInformation-r13 | |
|---|---|---|
| | | OPTIONAL, |
| tbs-ProvideLocationInformation-r13 | TBS-ProvideLocationInformation-r13 | OPTIONAL, |
| wlan-ProvideLocationInformation-r13 | WLAN-ProvideLocationInformation-r13 | OPTIONAL, |
| bt-ProvideLocationInformation-r13 | BT-ProvideLocationInformation-r13 | OPTIONAL |

]],

| | |
|---|---|
| [[ | nr-ECID-ProvideLocationInformation-r16 |

| | |
|---|---|
| NR-ECID-ProvideLocationInformation-r16 | OPTIONAL, |

nr-Multi-RTT-ProvideLocationInformation-r16

| | |
|---|---|
| NR-Multi-RTT-ProvideLocationInformation-r16 | OPTIONAL, |

nr-DL-AoD-ProvideLocationInformation-r16

| | |
|---|---|
| NR-DL-AoD-ProvideLocationInformation-r16 | OPTIONAL, |

nr-DL-TDOA-ProvideLocationInformation-r16

| | |
|---|---|
| NR-DL-TDOA-ProvideLocationInformation-r16 | OPTIONAL |

]]
}

In the current 3GPP Rel-17, work items for reducing location estimation service latency are defined as in Table 6 below.

TABLE 6

| ● | Specify the enhancements of signalling, and procedures for improving | |
|---|---|---|
| | positioning latency of the Rel-16 NR positioning methods, for DL and DL+UL | |
| | positioning methods, including: | |
| | ◯ | Latency reduction related to the request and response of location |
| | | measurements or location estimate and positioning assistance data; |
| | | [RAN2, RAN3, RAN1] |
| | ◯ | Latency reduction related to the time needed to perform UE measurements; |
| | | [RAN1, RAN4] |
| | ◯ | Latency reduction related to the measurement gap; [RAN1, RAN4, RAN2] |

Requirements for latency of location estimation in the Rel-17 are defined in TR 38.857 as in Table 7 below.

TABLE 7

| ● | In Rel-17 target positioning requirements for commercial use cases are defined | |
|---|---|---|
| | as follows: | |
| | ◯ | Horizontal position accuracy (< 1 m) for 90% of UEs |
| | ◯ | Vertical position accuracy (< 3 m) for 90% of UEs |
| | ◯ | End-to-end latency for position estimation of UE (< 100 ms) |
| | ◯ | Physical layer latency for position estimation of UE (< 10 ms) |

A target end-to-end delay (a time taken for the LMF to obtain a final estimation result after starting the location estimation procedure) is 100 milliseconds (msec) in the current Rel-17.

There is a discussion going on for modifying a response time in the LPP request location information message 1g-20 transmitted by the current LMF to request measurement information relating to location estimation from the UE to be expressed in up to tens of milliseconds. When receiving the LPP request location information message from the LMF, the UE needs to complete the measurement for location estimation within the response time specified in the message and add the resultant value to the LPP provide location information message 1g-20 to be sent to the LMF. ASN. 1 definitions and descriptions of the response time in the current standard are as in Tables 8 and 9 below.

TABLE 8
ResponseTime ::= SEQUENCE {

| | |
|---|---|
| time | INTEGER (1..128), |

...,

| | | |
|---|---|---|
| [[ responseTimeEarlyFix-r12 | INTEGER (1..128) | OPTIONAL -- Need ON |

]],

| | | |
|---|---|---|
| [[ unit-r15 | ENUMERATED { ten-seconds, ... } | OPTIONAL -- Need ON |

]]
}

TABLE 9

| - | responseTime | |
|---|---|---|
| | - | time indicates the maximum response time as measured between |
| | | receipt of the RequestLocationInformation and |
| | | transmission of a ProvideLocationInformation. If the unit |
| | | field is absent, this is given as an integer number of seconds |
| | | between 1 and 128. If the unit field is present, the maximum |
| | | response time is given in units of 10-seconds, between 10 |
| | | and 1280 seconds. If the periodicalReporting IE is included in |
| | | CommonIEsRequestLocationInformation, this field should |
| | | not be included by the location server and shall be ignored by |
| | | the target device (if included). |
| | - | unit indicates the unit of the time and response TimeEarlyFix fields. |

Enumerated value ‘ten-seconds’ corresponds to a
resolution of 10 seconds. If this field is absent, the unit/resolution
is 1 second.

As described above, a range of the response time that may be expressed in the current standard is 1 to 1280 seconds, and it may be understood that the expression unit of the response time is too big in consideration of 100 msec of the target end-to-end delay in the Rel-17. There are proposals for modification for enabling a response time to be set to tens of milliseconds, and many companies have agreed for the necessity of such modification, so the related contents are expected to be agreed in a stage of discussing the future Stage3 standard. Hence, the disclosure aims to provide an apparatus that is able to take into account a capability of the UE when the LMF determines a response time, given that whether the milliseconds of response time may be supported depends on low-latency measurement and response capability (i.e., low-latency capability) of the UE when the milliseconds of response time is introduced. For this, information about the low-latency capability of the UE is defined and added to the LPP request/provide capability message in the disclosure. How the UE/LMF each uses the information added to the LPP request/provide capability message is defined as well.

FIG. 1H is a sequence chart showing how an LPP request/provide capability enhanced for low-latency capability exchange of a UE is used in a procedure for handling an LCS request 1h-5a/b received by an LMF 1h-03, according to an embodiment of the disclosure.

Referring to FIG. 1H, the LMF 1h-03 may receive, from a UE 1h-01 and another LCS client 1h-04, a request message 1h-5a/b for UE location estimation service. The LCS request message 1h-5a/b may include the following requirements:
a requirement for location estimation accuracy

(For example, a requirement for horizontal and vertical location error ranges may be included).
a requirement for a time at which a location estimation result is obtained

(For example, an absolute time at which a location estimation result is to be obtained or a delay time given until a location estimation result is obtained after a request for location estimation may be included).

Afterward, the LMF 1h-03 may send an LPP request capabilities message 1h-10 to the UE 1h-01 to obtain UE capability information relating to location estimation. In this case, the LMF 1h-03 may add an indicator for requesting low-latency capability information of the UE 1h-01 to the message as described below. (It may be indicated in two types depending on whether each location estimation method has an individual indicator).
i) type 1 (the indicator is included only in a common information part. Each location estimation method may not use an individual indicator.)

TABLE 10
RequestCapabilities ::= SEQUENCE {

| criticalExtensions | | CHOICE { |
|---|---|---|
| | c1 | CHOICE { |
| | requestCapabilities-r9 | RequestCapabilities-r9-IEs, |
| | spare3 NULL, spare2 NULL, spare1 NULL | |
| | }, | |
| | criticalExtensionsFuture | SEQUENCE { } |

}
}
RequestCapabilities-r9-IEs ::= SEQUENCE {

| | | |
|---|---|---|
| commonIEsRequestCapabilities | CommonIEsRequestCapabilities | OPTIONAL, -- Need ON |
| a-gnss-RequestCapabilities | A-GNSS-RequestCapabilities | OPTIONAL, -- Need ON |
| otdoa-RequestCapabilities | OTDOA-RequestCapabilities | OPTIONAL, -- Need ON |
| ecid-RequestCapabilities | ECID-RequestCapabilities | OPTIONAL, -- Need ON |
| epdu-RequestCapabilities | EPDU-Sequence | OPTIONAL, -- Need ON |

...,

| | | | |
|---|---|---|---|
| [[ | sensor-RequestCapabilities-r13 | Sensor-RequestCapabilities-r13 | OPTIONAL, -- Need ON |
| | tbs-RequestCapabilities-r13 | TBS-RequestCapabilities-r13 | OPTIONAL, -- Need ON |
| | wlan-RequestCapabilities-r13 | WLAN-RequestCapabilities-r13 | OPTIONAL, -- Need ON |
| | bt-RequestCapabilities-r13 | BT-RequestCapabilities-r13 | OPTIONAL -- Need ON |

]],

| [[ | nr-ECID-RequestCapabilities-r16 | NR-ECID-RequestCapabilities-r16 | OPTIONAL, -- Need ON |
|---|---|---|---|
| | nr-Multi-RTT-RequestCapabilities-r16 | | |
| | | NR-Multi-RTT-RequestCapabilities-r16 | |
| | | | OPTIONAL, -- Need ON |
| | nr-DL-AoD-RequestCapabilities-r16 | | |
| | | NR-DL-AoD-RequestCapabilities-r16 | OPTIONAL, -- Need ON |
| | nr-DL-TDOA-RequestCapabilities-r16 | | |
| | | NR-DL-TDOA-RequestCapabilities-r16 | OPTIONAL, -- Need ON |
| | nr-UL-RequestCapabilities-r16 | NR-UL-RequestCapabilities-r16 | OPTIONAL -- Need ON |

]]
}

The indicator may be included in a commonIEsRequestCapabilities IE in RequestCapabilities.

```
TABLE 11
CommonIEsRequestCapabilities ::= SEQUENCE {
  ...,
  [[
```

| | | |
|---|---|---|
| lpp-message-segmentation-req-r14 | BIT STRING { | serverToTarget (0), |

targetToServer (1) } OPTIONAL -- Need ON

```
  ]]
  [[
```

| | | |
|---|---|---|
| lpp-LowLatencyResponseReq-r17 | BOOLEAN | OPTIONAL -- Need ON |

]]
}

As in what is underlined in ASN. 1 definitions of Table 11, a 1-bit indicator (Ipp-LowLatencyResponseReq-r17) for requesting low-latency capability information of the UE 1h-01 may be added to the CommonIEsRequestCapabilities IE.
ii) type 2 (an individual indicator is used for each location estimation method.)

TABLE 12
RequestCapabilities-r9-IEs ::= SEQUENCE {

| | | |
|---|---|---|
| commonIEsRequestCapabilities | CommonIEsRequestCapabilities | OPTIONAL, -- Need ON |
| a-gnss-RequestCapabilities | A-GNSS-RequestCapabilities | OPTIONAL, -- Need ON |
| otdoa-RequestCapabilities | OTDOA-RequestCapabilities | OPTIONAL, -- Need ON |
| ecid-RequestCapabilities | ECID-RequestCapabilities | OPTIONAL, -- Need ON |
| epdu-RequestCapabilities | EPDU-Sequence | OPTIONAL, -- Need ON |

...,

| | | | |
|---|---|---|---|
| [[ | sensor-RequestCapabilities-r13 | Sensor-RequestCapabilities-r13 | OPTIONAL, -- Need ON |
| | tbs-RequestCapabilities-r13 | TBS-RequestCapabilities-r13 | OPTIONAL, -- Need ON |
| | wlan-RequestCapabilities-r13 | WLAN-RequestCapabilities-r13 | OPTIONAL, -- Need ON |
| | bt-RequestCapabilities-r13 | BT-RequestCapabilities-r13 | OPTIONAL -- Need ON |

]],

| [[ | nr-ECID-RequestCapabilities-16 | NR-ECID-RequestCapabilities-r16 | OPTIONAL, -- Need ON |
|---|---|---|---|
| | nr-Multi-RTT-RequestCapabilities-r16 | | |
| | | NR-Multi-RTT-RequestCapabilities-r16 | |
| | | | OPTIONAL, -- Need ON |
| | nr-DL-AoD-RequestCapabilities-r16 | | |
| | | NR-DL-AoD-RequestCapabilities-r16 | OPTIONAL, -- Need ON |
| | nr-DL-TDOA-RequestCapabilities-r16 | | |
| | | NR-DL-TDOA-RequestCapabilities-r16 | OPTIONAL, -- Need ON |
| | nr-UL-RequestCapabilities-r16 | NR-UL-RequestCapabilities-r16 | OPTIONAL -- Need ON |

]]
}

An individual indicator may be included in a RequestCapabilities IE for each location estimation method in RequestCapabilities.

```
TABLE 13
ECID-RequestCapabilities ::= SEQUENCE {
  ...,
  [[
```

| | |
|---|---|
| lpp-LowLatencyResponseReq-r17 | BOOLEAN OPTIONAL -- Need ON |

]]
}

ASN. 1 definitions of Table 13 show an example of including an individual indicator in a RequestCapabilities IE corresponding to an ECID method. An individual indicator may be included in a RequestCapabilities IE for each location estimation method in a similar manner.

On receiving an LPP request capabilities message 1h-10 from the LMF 1h-03, the UE 1h-01 may, in response, send an LPP provide capabilities message 1h-15. In this case, when an indicator for requesting the low-latency capability information is included in the LPP request capabilities message 1h-10, the UE may add related information into the LPP provide capabilities message 1h-15 as follows. (It may be represented in two types depending on whether the low-latency capability information of the UE 1h-01 is included separately for each location estimation method as in the LPP request capabilities message 1h-10.)
i) type 1 (the low-latency capability information of the UE is included only in a common information part. Individual information for each location estimation method may not be included.)

TABLE 14
ProvideCapabilities ::= SEQUENCE {

| criticalExtensions | | CHOICE { |
|---|---|---|
| | c1 | CHOICE { |
| | provideCapabilities-r9 | ProvideCapabilities-r9-IEs, |
| | spare3 NULL, spare2 NULL, spare1 NULL | |
| | }, | |
| | criticalExtensionsFuture | SEQUENCE { } |

}
}
ProvideCapabilities-r9-IEs ::= SEQUENCE {

| | | |
|---|---|---|
| commonIEsProvideCapabilities | CommonIEsProvideCapabilities | OPTIONAL, |
| a-gnss-ProvideCapabilities | A-GNSS-ProvideCapabilities | OPTIONAL, |
| otdoa-ProvideCapabilities | OTDOA-ProvideCapabilities | OPTIONAL, |
| ecid-ProvideCapabilities | ECID-ProvideCapabilities | OPTIONAL, |
| epdu-ProvideCapabilities | EPDU-Sequence | OPTIONAL, |

...,

| | | | |
|---|---|---|---|
| [[ | sensor-ProvideCapabilities-r13 | Sensor-ProvideCapabilities-r13 | OPTIONAL, |
| | tbs-ProvideCapabilities-r13 | TBS-ProvideCapabilities-r13 | OPTIONAL, |
| | wlan-ProvideCapabilities-r13 | WLAN-ProvideCapabilities-r13 | OPTIONAL, |
| | bt-ProvideCapabilities-r13 | BT-ProvideCapabilities-r13 | OPTIONAL |

]],

| [[ | nr-ECID-ProvideCapabilities-r16 | NR-ECID-ProvideCapabilities-r16 | OPTIONAL, |
|---|---|---|---|
| | nr-Multi-RTT-ProvideCapabilities-r16 | | |
| | | NR-Multi-RTT-ProvideCapabilities-r16 | OPTIONAL, |
| | nr-DL-AoD-ProvideCapabilities-r16 | | |
| | | NR-DL-AoD-ProvideCapabilities-r16 | OPTIONAL, |
| | nr-DL-TDOA-ProvideCapabilities-r16 | | |
| | | NR-DL-TDOA-ProvideCapabilities-r16 | OPTIONAL, |
| | nr-UL-ProvideCapabilities-r16 | NR-UL-ProvideCapabilities-r16 | OPTIONAL |

]]
}

The low-latency capability information of the UE 1h-01 may be included in a commonIEsProvideCapabilities IE in ProvideCapabilities.

```
TABLE 15
CommonIEsProvideCapabilities ::= SEQUENCE {
  ...,
  [[
```

| segmentationInfo-r14 | SegmentationInfo-r14 | OPTIONAL, -- Cond Segmentation |
|---|---|---|
| lpp-message-segmentation-r14 | BIT STRING { serverToTarget (0), | |
| | targetToServer (1) } | OPTIONAL |

```
  ]]
  [[
```

| | |
|---|---|
| lpp-LowLatencyResponse-r17 | ENUMERATED {supported} OPTIONAL |

]]
}

As described in the ASN. 1 definitions of Table 15, whether the UE 1h-01 supports low-latency measurement and response (Ipp-LowLatencyResponse-r17) may be added into a CommonIEsProvideCapabilities IE.
ii) type 2 (separate low-latency measurement and response capability information of the UE 1h-01 for each location estimation method is included.)

TABLE 16
ProvideCapabilities ::= SEQUENCE {

| criticalExtensions | | CHOICE { |
|---|---|---|
| | c1 | CHOICE { |
| | provideCapabilities-r9 | ProvideCapabilities-r9-IEs, |
| | spare3 NULL, spare2 NULL, spare1 NULL | |
| | }, | |
| | criticalExtensionsFuture | SEQUENCE { } |

}
}
ProvideCapabilities-r9-IEs ::= SEQUENCE {

| | | |
|---|---|---|
| commonIEsProvideCapabilities | CommonIEsProvideCapabilities | OPTIONAL, |
| a-gnss-ProvideCapabilities | A-GNSS-ProvideCapabilities | OPTIONAL, |
| otdoa-ProvideCapabilities | OTDOA-ProvideCapabilities | OPTIONAL, |
| ecid-ProvideCapabilities | ECID-ProvideCapabilities | OPTIONAL, |
| epdu-ProvideCapabilities | EPDU-Sequence | OPTIONAL, |

...,

| | | | |
|---|---|---|---|
| [[ | sensor-ProvideCapabilities-r13 | Sensor-ProvideCapabilities-r13 | OPTIONAL, |
| | tbs-ProvideCapabilities-r13 | TBS-ProvideCapabilities-r13 | OPTIONAL, |
| | wlan-ProvideCapabilities-r13 | WLAN-ProvideCapabilities-r13 | OPTIONAL, |
| | bt-ProvideCapabilities-r13 | BT-ProvideCapabilities-r13 | OPTIONAL |

]],

| [[ | nr-ECID-ProvideCapabilities-r16 | NR-ECID-ProvideCapabilities-r16 | OPTIONAL, |
|---|---|---|---|
| | nr-Multi-RTT-ProvideCapabilities-r16 | | |
| | | NR-Multi-RTT-ProvideCapabilities-r16 | OPTIONAL, |
| | nr-DL-AoD-ProvideCapabilities-r16 | | |
| | | NR-DL-AoD-ProvideCapabilities-r16 | OPTIONAL, |
| | nr-DL-TDOA-ProvideCapabilities-r16 | | |
| | | NR-DL-TDOA-ProvideCapabilities-r16 | OPTIONAL, |
| | nr-UL-ProvideCapabilities-r16 | NR-UL-ProvideCapabilities-r16 | OPTIONAL |

]]
}

The low-latency measurement and response capability information of the UE 1h-01 may be individually included in a ProvideCapabilities IE for each location estimation method included in ProvideCapabilities.

TABLE 17
ECID-ProvideCapabilities ::= SEQUENCE {

| | | |
|---|---|---|
| ecid-MeasSupported BIT STRING { | rsrpSup | (0), |
| | rsrqSup | (1), |
| | ueRxTxSup | (2), |
| | nrsrqSup-r14 | (3), |
| | nrsrqSup-r14 | (4)} (SIZE(1..8)), |

...,

| | | | |
|---|---|---|---|
| [[ | ueRxTxSupTDD-r13 | ENUMERATED { true } | OPTIONAL |

]],

| | | | |
|---|---|---|---|
| [[ | periodicalReporting-r14 | ENUMERATED { supported } | OPTIONAL, |
| | triggeredReporting-r14 | ENUMERATED { supported } | OPTIONAL, |
| | idleStateForMeasurements-r14 | ENUMERATED { required } | OPTIONAL |

```
  ]],
  [[
```

| | |
|---|---|
| lpp-LowLatencyResponse-r17 | ENUMERATED {supported} OPTIONAL |

]]
}

The ASN.1 definitions of Table 17 show an example of individually including whether the UE 1h-01 supports low-latency measurement and response (Ipp-LowLatencyResponse-r17) in a ProvideCapabilities IE corresponding to the ECID method. Individual low-latency capability information may be included in a ProvideCapabilities IE for each location estimation method in a similar manner.

The LMF 1h-03 may select schemes that may satisfy location estimation service requirements included in the LCS request message 1h-5a/b from among location estimation schemes that may be supported by the UE 1h-01, based on UE capability information included in the LPP provide capabilities message 1h-15. Afterward, the LMF 1h-03 may send the UE 1h-01 assistance information to be additionally provided for each selected scheme. The UE 1h-01 may determine if whether to support the low-latency measurement and response is changed for each location estimation scheme, based on information included in LPP provide assistance data 1h-20. For example, in a case of GNSS based location estimation scheme, a value of Ipp-LowLatencyResponse-r17 is denoted as ‘not-supported’ in an A-GNSS-ProvideCapabilities IE included in the LPP provide capabilities message 1h-15 that is transmitted by the UE 1h-01. This may mean that the UE has difficulty in low-latency measurement and response because a delay time required to receive satellite signals required for GNSS based location estimation and derive a measurement result is so long. However, when the assistance information for advancing a satellite signal reception time is included in the LPP provide assistance data message 1h-20 received by the UE 1h-01, and the UE 1h-01 determines that low-latency measurement and response may be supported because a time for satellite signal measurement and response is significantly reduced by using the assistance information, the UE 1h-01 may change the value of Ipp-LowLatencyResponse-r17 in the A-GNSS-ProvideCapabilities IE of the LPP provide capabilities message 1h-25 into ‘supported’ and send it to the LMF 1h-03.

In operation 1h-30, the LMF 1h-03 may set an optimal location estimation scheme and a response time required for satisfying requirements (accuracy and time) in location estimation included in the LCS request message 1h-5a/b, based on the low-latency capability information obtained of the UE 1h-01. Afterward, the LMF 1h-03 may transmit an LPP request location information message 1h-35 to the UE 1h-01, and the message 1h-35 may include a description of measurement to be performed and location information and a response time value to be responded by the UE 1h-01. The UE 1h-01 may perform signal measurement requested by the LMF 1h-03 in operation 1h-40. As summarized below, an operation of responding with an LPP provide location information message 1h-45 may vary depending on whether the UE 1h-01 is ready to transmit a response message after finishing measurement of required signals in a given response time. (The following operations are defined by the TS 38.305 standard).
when the UE 1h-01 is ready for signal measurement and response within a response time given by the LMF 1h-03, the UE may immediately transmit, to the LMF 1h-03, the LPP provide location information message 1h-45 including a result of the requested measurement.
when the UE 1h-01 is not ready for signal measurement and response within the response time given by the LMF 1h-03, the UE may transmit, to the LMF 1h-03, the LPP provide location information message 1h-45 at a time when the response time is up. In this case, the LPP provide location information message 1h-45 may include information about a cause that the UE 1h-01 fails to provide the requested location information.

The LMF 1h-03 may determine a result of estimation of the location of the UE 1h-01 in operation 1h-50 based on the LPP provide location information 1h-45 provided by the UE 1h-01. Afterward, the LMF 1h-03 may respond with an LCS response message 1h-55a/b corresponding to the LCS request message 1h-5a/b received from the UE 1h-01 and the other LCS client 1h-04.

FIG. 1I is a flowchart of a procedure in which an LMF handles an LCS request based on low-latency capability information of a UE, according to an embodiment of the disclosure.

Referring to FIG. 1I, a location estimation request handling procedure begins when the LMF receives an LCS request from an LCS client, and the procedure is finished when the LMF responds to the LCS client with an LCS response (actual exchange of the LCS request/response message may be performed via an AMF).

In operation 1i-05, the LMF may receive an LCS request message.

In an embodiment, the LMF may start a procedure for handling a location estimation service request after receiving the LCS request message from the LCS client.

The LCS request message may include information about requirements (accuracy and time) for location estimation. For example, an acceptable range of the horizontal/vertical location error may be included in meters for the information about accuracy, and information about a time at which the location estimation result is to be obtained may be included in the form of an absolute time or of an allowable delay time from the current time for the information about time.

In operation 1i-10, the LMF may send an LPP request capabilities message.

In an embodiment, the LMF may select schemes that satisfy the requirements included in the LCS request from among the supportable location estimation schemes. For example, when a requirement about accuracy included in the LCS request message is to guarantee less than a few meters of error range, the LMF may exclude location measurement schemes that are originally unable to provide the required level of accuracy from candidate location measurement schemes.

The LMF may send an LPP request capabilities message to request a UE capability related to the selected schemes.

When low-latency measurement and response is required according to the requirement related to the location estimation time included in the LCS request message, an indicator to request low-latency capability information of the UE may be included in the LPP request capabilities message as well.

In operation 1i-15, the LMF may receive an LPP provide capabilities message.

In an embodiment, the LMF may receive information about the UE capability requested in operation 1i-15.

When the indicator to request low-latency capability of the UE is included in the LPP request capabilities message, associated information may be included in the LPP provide capabilities message.

The LMF may select schemes that satisfy the requirements included in the LCS request message one more from among the location estimation schemes selected in operation 1i-10, based on the UE capability information included in the LPP provide capabilities message. For example, location estimation schemes that are not originally supported by the UE may be excluded from the candidate schemes. In addition, when the LMF requires low-latency measurement and response according to the requirements included in the LCS request message, the location estimation schemes for which the UE does not support low-latency measurement and response may be excluded from available candidates.

In operation 1i-20, the LMF may send an LPP provide assistance data message.

In an embodiment, the LMF may transmit, to the UE, assistance information additionally required by the UE for signal measurement for the location estimation scheme selected in operation 1i-15 in the LPP provide assistance message.

When assistance information that may influence whether the UE supports low-latency measurement and response is included in the LPP provide assistance message, the UE may send an additional LPP provide capabilities message to update information about a related capability in operation 1i-25. Accordingly, in such a case, the LMF may (re)start a newly introduced timer Txxx and wait for additional message transmission from the UE. When the timer is expired, operation 1i-25 may be skipped and the process may go to operation 1i-30.

In operation 1i-30, the LMF may determine whether LCS QoS is satisfied.

In an embodiment, the LMF may select a best location estimation scheme that satisfies the requirements (accuracy and time) included in the LCS request message, based on information about a UE capability related to location estimation obtained in operations 1i-10 to 1i-25.

When it is determined that there is no location estimation scheme that satisfies the requirements given in the location estimation selection process, the LMF may move to operation 1i-35 to determine an LCS QoS class.

Otherwise, when the best location estimation scheme that satisfies the given requirements, the process may go to operation 1i-45.

In operation 1i-35, the LMF may determine the LCS QoS class.

In an embodiment, the LMF may determine the LCS QoS class included in the LCS request message received in operation 1i-05.

When the LCS QoS class corresponds to ‘assured’, the LMF may skip operations 1i-45 to 1i-55, and finish the LCS request handling procedure by sending an LSC response message to the LCS client in operation 1i-40. In this case, the LCS response message may include only a cause of an error without a result of estimation of the location of the UE.

When the LCS QoS class corresponds to ‘best effort’, the LMF may select a location estimation scheme that is able to provide a location estimation service result at the closest level to the requirements included in the LCS request message yet unable to satisfy the requirements, and proceeds to operation 1i-45.

In operation 1i-45, the LMF may send an LPP request location information message.

In an embodiment, the LMF may determine location information (a signal measurement result or location estimation result of the UE) to be requested from the UE to use the location estimation scheme selected in operation 1i-30 or 1i-35 and a request time value to obtain the location estimation result within the given time.

The LMF may add the location information and the request time to the LPP request location information message to be sent to the UE.

In operation 1i-50, the LMF may receive an LPP provide location information message. (1i-50)

In an embodiment, the LMF may receive the LPP provide location information message from the UE.

When the LPP provide location information message includes location information requested in operation 1i-45, the LMF may determine a result of estimation of a location of the UE based on the location information and send the result to an LCS client in an LCS response in operation 1i-55.

When the LPP provide location information message includes an indicator about a cause of failing to provide the location information requested in operation 1i-45, the LMF may send the cause of the failing to the LCS client in an LCS response message.

FIG. 1J is a block diagram illustrating an internal structure of a UE, according to an embodiment of the disclosure.

Referring to FIG. 1J, a UE may include a radio frequency (RF) processor 1j-10, a baseband processor 1j-20, a storage 1j-30, and a controller 1j-40.

In an embodiment, the RF processor 1j-10 may perform functions, such as band conversion, amplification, etc., of a signal to transmit or receive the signal on a wireless channel. Specifically, the RF processor 1j-10 may up-convert a baseband signal provided from the baseband processor 1j-20 to an RF band signal for transmission through an antenna, and down-convert an RF band signal received through the antenna to a baseband signal. For example, the RF processor 1j-10 may include a transmit filter, a receive filter, an amplifier, a mixer, an oscillator, a digital to analog converter (DAC), an analog to digital converter (ADC), etc. Although a single antenna is shown in FIG. 1J, the UE may be equipped with a plurality of antennas. The RF processor 1j-10 may also include a plurality of RF chains. Furthermore, the RF processor 1j-10 may perform beamforming. For beamforming, the RF processor 1j-10 may control the phase and amplitude of each signal to be transmitted or received through a plurality of antennas or antenna elements. Furthermore, the RF processor 1j-10 may perform multiple-input-multiple-output (MIMO), and may receive a number of layers during the MIMO operation.

In an embodiment, the baseband processor 1j-20 may perform a conversion function between a baseband signal and a bitstream according to a physical layer standard of the system. For example, for data transmission, the baseband processor 1j-20 may generate complex symbols by encoding and modulating a bit sequence for transmission. Furthermore, upon reception of data, the baseband processor 1j-20 may reconstruct a received bitstream by demodulating and decoding a baseband signal provided from the RF processor 1j-10. For example, when conforming to an OFDM method, for data transmission, the baseband processor 1j-20 may generate complex symbols by encoding and modulating a bitstream for transmission, map the complex symbols to subcarriers, and then reconstruct OFDM symbols by inverse fast Fourier transform (IFFT) operation and cyclic prefix (CP) insertion. Furthermore, upon reception of data, the baseband processor 1j-20 may divide a baseband signal provided from the RF processor 1j-10 into OFDM symbols, reconstruct signals mapped to subcarriers through fast Fourier transform (FFT), and restore a received bitstream by demodulation and decoding.

The baseband processor 1j-20 and the RF processor 1j-10 may transmit and receive signals as described above. Hence, the baseband processor 1j-20 and the RF processor 1j-10 may be referred to as a transmitter, a receiver, a transceiver, or a communicator. Furthermore, at least one of the baseband processor 1j-20 or the RF processor 1j-10 may include multiple communication modules to support many different radio access technologies. In addition, at least one of the baseband processor 1j-20 or the RF processor 1j-10 may include different communication modules to process different frequency band signals. For example, the different radio access technologies may include a wireless local area network (WLAN), e.g., the IEEE 802.11, a cellular network, e.g., LTE, etc. Furthermore, the different frequency bands may include a super high frequency (SHF) band, e.g., 2.NRHz, NRhz, and millimeter wave (mmwave) band, e.g., 60 GHz.

In an embodiment, the storage 1j-30 may store a basic program, an application program, data like settings information, etc., for operation of the UE. Especially, the storage 1j-30 may use a second radio access technology to store information relating to a second access node that performs wireless communication. The storage 1j-30 provides data stored therein at the request of the controller 1j-40.

The controller 1j-40 may control general operations of the UE according to an embodiment of UE. For example, the controller 1j-40 may transmit or receive signals through the baseband processor 1j-20 and the RF processor 1j-10. The controller 1j-40 may also record or read data onto or from the storage 1j-40. For this, the controller 1j-40 may include at least one processor. For example, the controller 1j-40 may include a communication processor (CP) for controlling communication and an application processor (AP) for controlling a higher layer, such as an application program.

In an embodiment, the controller 1j-40 may include a multi-connection processor 1j-42.

FIG. 1K is a block diagram illustrating a configuration of an NR BS, according to an embodiment of the disclosure.

As shown in FIG. 1K, the BS may include an RF processor 1k-10, a baseband processor 1k-20, a communicator 1k-30, a storage 1k-40, and a controller 1k-50.

In an embodiment, the RF processor 1k-10 may perform functions, such as band conversion, amplification, etc., of a signal to transmit or receive the signal on a wireless channel. Specifically, the RF processor 1k-10 may up-convert a baseband signal provided from the baseband processor 1k-20 to an RF band signal for transmission through an antenna, and down-convert an RF band signal received through the antenna to a baseband signal. For example, the RF processor 1k-10 may include a transmit filter, a receive filter, an amplifier, a mixer, an oscillator, a DAC, an ADC, etc. Although only one antenna is shown in FIG. 1K, a first access node may include a plurality of antennas. The RF processor 1k-10 may also include a plurality of RF chains. Furthermore, the RF processor 1k-10 may perform beamforming. For beamforming, the RF processor 1k-10 may control the phase and amplitude of each signal to be transmitted or received through a plurality of antennas or antenna elements. The RF processor 1k-10 may perform downstream MIMO operation by transmitting one or more layers.

The baseband processor 1k-20 may perform conversion between a baseband signal and a bitstream according to a physical layer standard of a first radio access technology in an embodiment. For example, for data transmission, the baseband processor 1k-20 may generate complex symbols by encoding and modulating a bit sequence for transmission. Furthermore, upon reception of data, the baseband processor 1k-20 may reconstruct a received bitstream by demodulating and decoding a baseband signal provided from the RF processor 1k-10. For example, when conforming to an OFDM method, for data transmission, the baseband processor 1k-20 may generate complex symbols by encoding and modulating a bitstream for transmission, map the complex symbols to subcarriers, and then reconstruct OFDM symbols by IFFT operation and CP insertion. Furthermore, upon reception of data, the baseband processor 1k-20 may divide a baseband signal provided from the RF processor 1k-10 into OFDM symbols, reconstruct signals mapped to subcarriers through FFT operation, and restore a received bitstream by demodulation and decoding. The baseband processor 1k-20 and the RF processor 1k-10 may transmit and receive signals as described above. Hence, the baseband processor 1k-20 and the RF processor 1k-10 may be referred to as a transmitter, a receiver, a transceiver, a communicator, or a wireless communicator.

The communicator 1k-30 may provide an interface for communicating with other nodes in the network according to an embodiment. For example, the communicator 1k-30 may convert a bit sequence to be transmitted from a primary BS to another node, e.g., a secondary BS, a core network, etc., into a physical signal, and convert a physical signal received from another node to a bit sequence.

In an embodiment, the storage 1k-40 may store a basic program, an application program, data like settings information for operation of the UE. In particular, the storage 1k-40 may store information about a bearer allocated to a connected UE, measurements reported from the UE, etc. Furthermore, the storage 1k-40 may store information used as a criterion for determining whether to provide or stop multi-connection for the UE. The storage 1k-40 may provide data stored therein at the request of the controller 1k-50.

The controller 1k-50 may control general operations of the primary BS according to an embodiment. For example, the controller 1k-50 may transmit or receive signals through the baseband processor 1k-20 and the RF processor 1k-10 or the communicator 1k-30. The controller 1k-50 may also record or read data onto or from the storage 1k-40. For this, the controller 1k-50 may include at least one processor.

In an embodiment, the controller 1k-50 may include a multi-connection processor 1k-52.

FIG. 1L is a diagram for describing a network entity, according to an embodiment of the disclosure.

A network entity 1l-10 may include a processor 1l-20, a communicator 1l-30, and a memory 1l-40. However, not all the components shown is required, and the network entity 1l-10 may be implemented with more or less components than those shown. The processor 1l-20, the communicator 1l-30 and the memory 1l-40 may be implemented in a single chip in some cases.

The processor 1l-20 may include one or more processors or other processing devices that control functions, processes, and/or methods proposed in the disclosure. Operation of the network entity 1l-10 may be implemented by the processor 1l-20.

The communicator 1l-30 may include an RF transmitter for up-converting and amplifying a transmitted signal, and a RF receiver for down-converting the frequency of a received signal. In another embodiment, the communicator 1l-30 may implemented with more or less components than shown herein.

The communicator 1l-30 may be connected to the processor 1l-20 for transmitting and/or receive signal. The signal may include control information and data. In addition, the communicator 1l-30 may receive a signal through a wireless channel and may output the signal to the processor 1l-20. The communicator 1l-30 may transmit a signal output from the processor 1l-20 through a wireless channel.

The memory 1l-40 may store the control information or the data included in the signal obtained by the network entity 1l-10. The memory 1l-40 may be connected to the processor 1l-20 and may store at least one instruction, a protocol or a parameter for the proposed function, process, and/or method. The memory 1l-40 may include read-only memory (ROM) and/or random-access memory (RAM) and/or hard disk and/or compact disc ROM (CD-ROM) and/or digital versatile disc (DVD) and/or other storage device.

1. A user equipment (UE) in a wireless communication system, the UE comprising:
a transceiver; and
at least one processor coupled to the transceiver,
wherein the at least one processor is configured to:
receive, from a network entity, a long-term evolution (LTE) positioning protocol (LPP) request capabilities message requesting capability information of the UE for one or more location estimation methods, and
transmit, to the network entity, an LPP provide capabilities message including capability information of the UE for at least one location estimation method the UE supports among the one or more location estimation methods, and
wherein the LPP provide capabilities message comprises information indicating whether the UE supports a response time in units of 10 milliseconds for the at least one location estimation methods.

2. The UE of claim 1, wherein:
the LPP provide capabilities message comprises a provide capabilities information element (IE) corresponding to a first location method of the at least one location estimation method, and
the provide capabilities IE comprises the information indicating whether the UE supports a response time in units of 10 milliseconds.

3. The UE of claim 1, wherein:
the at least one processor is configured to receive, from the network entity, an LPP request location information message requesting at least one of location measurement data or location estimation data, and
the LPP request location information message comprises a response time determined based on the information indicating whether the UE supports a response time in units of 10 milliseconds.

4. The UE of claim 1, wherein the at least one location estimation method comprises at least one of:
a new radio enhanced cell identity (NR ECID) location estimation method;
a new radio downlink time difference of arrival (NR DL-TDOA) location estimation method;
a new radio downlink angle of departure (NR DL-AoD) location estimation method; or
a new radio multi round-trip time positioning (NR multi-RTT) location estimation method.

5. A network entity in a wireless communication system, the network entity comprising:
a transceiver; and
at least one processor coupled to the transceiver,
wherein the at least one processor is configured to:
transmit, to a user equipment (UE), a long-term evolution (LTE) positioning protocol (LPP) request capabilities message requesting capability information of the UE for of one or more location estimation methods, and
receive, from the UE, an LPP provide capabilities message including capability information of the UE for at least one location estimation method the UE supports among the one or more location estimation methods, and
wherein the LPP provide capabilities message comprises information indicating whether the UE supports a response time in units of 10 milliseconds for the at least one location estimation methods.

6. The network entity of claim 5, wherein:
the LPP provide capabilities message comprises a provide capabilities information element (IE) corresponding to a first location method of the at least one location estimation method, and
the provide capabilities IE comprises the information indicating whether the UE supports a response time in units of 10 milliseconds.

7. The network entity of claim 5, wherein the at least one processor is configured to:
determine a response time based on the information indicating whether the UE supports a response time in units of 10 milliseconds, and
transmit, to the UE, an LPP request location information message requesting at least one of location measurement data or location estimation data, and
wherein the LPP request location information message comprises the determined response time.

8. The network entity of claim 5, wherein the at least one location estimation method comprises at least one of:
a new radio enhanced cell identity (NR ECID) location estimation method;
a new radio downlink time difference of arrival (NR DL-TDOA) location estimation method;
a new radio downlink angle of departure (NR DL-AoD) location estimation method; or
a new radio multi round-trip time positioning (NR multi-RTT) location estimation method.

9. A method performed by a user equipment (UE) in a wireless communication system, the method comprising:
receiving, from a network entity, a long-term evolution (LTE) positioning protocol (LPP) request capabilities message requesting capability information of the UE for one or more location estimation methods, and
transmitting, to the network entity, an LPP provide capabilities message including capability information of the UE for at least one location estimation method the UE supports among the one or more location estimation methods, and
wherein the LPP provide capabilities message comprises information indicating whether the UE supports a response time in units of 10 milliseconds for the at least one location estimation methods.

10. The method of claim 9, wherein:
the LPP provide capabilities message comprises a provide capabilities information element (IE) corresponding to a first location method of the at least one location estimation method, and
the provide capabilities IE comprises information indicating whether the UE supports a response time in units of 10 milliseconds.

11. The method of claim 9, further comprising:
receiving, from the network entity, an LPP request location information message requesting at least one of location measurement data or location estimation data,
wherein the LPP request location information message comprises a response time determined based on the information indicating whether the UE supports a response time in units of 10 milliseconds.

12. The method of claim 9, wherein the at least one location estimation method comprises at least one of:
a new radio enhanced cell identity (NR ECID) location estimation method;
a new radio downlink time difference of arrival (NR DL-TDOA) location estimation method;
a new radio downlink angle of departure (NR DL-AoD) location estimation method; or
a new radio multi round-trip time positioning (NR multi-RTT) location estimation method.

13. A method performed by a network entity in a wireless communication system, the method comprising:
transmitting, to a user equipment (UE), a long-term evolution (LTE) positioning protocol (LPP) request capabilities message requesting capability information of the UE for one or more location estimation methods; and
receiving, from the UE, an LPP provide capabilities message including capability information of the UE for at least one location estimation method the UE supports among the one or more location estimation methods,
wherein the LPP provide capabilities message comprises information indicating whether the UE supports a response time in units of 10 milliseconds for the at least one location estimation methods.

14. The method of claim 13, wherein:
the LPP provide capabilities message comprises a provide capabilities information element (IE) corresponding to a first location method of the at least one location estimation method, and
the provide capabilities IE comprises the information indicating whether the UE supports a response time of in units 10 milliseconds.

15. The method of claim 13, further comprising:
determining a response time based on the information indicating whether the UE supports a response time in units of 10 milliseconds; and
transmitting, to the UE, an LPP request location information message requesting at least one of location measurement data or location estimation data,
wherein the LPP request location information message comprises the determined response time.
